(19) United States
(12) Patent Application Publication
(10) Pub. No.: US 2017/0327730 A1
(43) Pub. Date: Nov. 16, 2017

(54) HYDROCARBON RECOVERY COMPOSITION AND A METHOD FOR USE THEREOF

(71) Applicant: SHELL OIL COMPANY, Houston, TX (US)

(72) Inventors: Lori Ann CROM, Houston, TX (US); Timothy Elton KING, Katy, TX (US); Julian Richard BARNES, Amsterdam (NL)

(21) Appl. No.: 15/666,602

(22) Filed: Aug. 2, 2017

(51) Int. Cl. C09K 8/58; E21B 43/26; E21B 43/16

(52) U.S. Cl. CPC C09K 8/58; E21B 43/16; E21B 43/26

(57) ABSTRACT

The invention relates to a hydrocarbon recovery composition comprising one or more internal olefin sulfonates and/or one or more alkoxylated alcohols and/or alkoxylated alcohol derivatives and a method of recovering hydrocarbons from a hydrocarbon formation comprising feeding a hydrocarbon recovery composition into the formation, allowing the hydrocarbon recovery composition to contact the formation for a period of time, and withdrawing a mixture of the hydrocarbon recovery composition and hydrocarbons from the formation.

### FIELD OF THE INVENTION

The present invention relates to a hydrocarbon recovery composition and a method of recovering hydrocarbons from a hydrocarbon formation.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation. For example, it is difficult to produce hydrocarbon from formations that are considered “tight” formations because of the extremely low permeability in the formation.

Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof.

### SUMMARY OF THE INVENTION

The invention provides a hydrocarbon recovery composition comprising one or more internal olefin sulfonates and/or one or more alkoxylated alcohols and/or alkoxylated alcohol derivatives.

The invention further provides a method of recovering hydrocarbons from a hydrocarbon formation comprising feeding a hydrocarbon recovery composition into the formation, allowing the hydrocarbon recovery composition to contact the formation for a period of time, and withdrawing a mixture of the hydrocarbon recovery composition and hydrocarbons from the formation.

### DETAILED DESCRIPTION OF THE INVENTION

The present invention relates to a hydrocarbon recovery composition comprising one or more internal olefin sulfonates and/or one or more alkoxylated alcohols and/or alkoxylated alcohol derivatives. Alkoxylated alcohols may also be referred to as alcohol alkoxylates. In one embodiment, the hydrocarbon recovery composition comprises a mixture of internal olefin sulfonates and alkoxylated alcohols, preferably a mixture of internal olefin sulfonates with alcohol ethoxylates. In this embodiment, the alcohol ethoxylates may have a high average EO number as described hereinbelow. In another embodiment, the hydrocarbon recovery composition comprises a mixture of internal olefin sulfonates and alcohol alkoxy sulfates. In a further embodiment, the hydrocarbon recovery composition comprises alkoxylated alcohols with a high average EO number, for example alcohol ethoxylates. A high average EO number is an average EO number of at least 20.

In one embodiment, the weight ratio of the alkoxylated alcohol and/or alkoxylated alcohol derivative to the internal olefin sulfonate is below 1:1. Preferably, the weight ratio is at least 1:100, more preferably at least 1:50, more preferably at least 1:20 and most preferably at least 1:10. Further, preferably, the weight ratio is at most 1:5.7, more preferably at most 1:4.0, more preferably at most 1:2.3, more preferably at most 1:1.5.

In another embodiment, the weight ratio of the internal olefin sulfonate to the alkoxylated alcohol and/or alkoxylated alcohol derivative is below 1:1. Preferably, the weight ratio is at least 1:100, more preferably at least 1:50, more preferably at least 1:20 and most preferably at least 1:10. Further, preferably, the weight ratio is at most 1:5.7, more preferably at most 1:4.0, more preferably at most 1:2.3, more preferably at most 1:1.5.

The hydrocarbon recovery composition preferably contains water. The active matter content of the aqueous hydrocarbon recovery composition is preferably at least 20 wt. %, more preferably at least 40 wt. %, more preferably at least 50 wt. %, most preferably at least 60 wt. %. “Active matter” herein means the total of anionic species in the aqueous composition, but excluding any inorganic anionic species, for example, sodium sulfate. The active matter content concerns the active matter content of the hydrocarbon recovery composition before it may be combined with a hydrocarbon removal fluid, which fluid may comprise water (e.g. a brine), to produce an injectable fluid, which injectable fluid may be injected into a hydrocarbon containing formation.

In general, stability of the hydrocarbon recovery composition components at a high temperature is relevant to prevent the components from being decomposed (for example hydrolyzed) at such high temperature. Internal olefin sulfonates (IOS) are known to be heat stable at temperatures of 60° C. or higher. However, in addition to being heat stable, a hydrocarbon recovery composition may also have to withstand a relatively high concentration of divalent cations. The high concentration of divalent cations may have the effect of precipitating the hydrocarbon recovery composition components out of solution. The hydrocarbon recovery composition should have an adequate aqueous solubility as that improves the injectability of the fluid comprising the hydrocarbon recovery composition to be injected into the hydrocarbon containing formation. Further, an adequate aqueous solubility reduces loss of the components through adsorption to rock or surfactant retention as trapped, viscous phases within the hydrocarbon containing formation. Precipitated solutions would not be suitable as they could result in formation plugging.

The hydrocarbon recovery composition comprises an internal olefin sulfonate which comprises internal olefin sulfonate molecules. An internal olefin sulfonate molecule is an alkene or hydroxyalkane which contains one or more sulfonate groups. Examples of such internal olefin sulfonate molecules are hydroxy alkane sulfonates (HAS) and alkene sulfonates (OS).

The internal olefin sulfonate (IOS) is prepared from an internal olefin by sulfonation. An internal olefin and an IOS comprise a mixture of internal olefin molecules and a mixture of IOS molecules, respectively. The molecules differ from each other, for example, in terms of carbon number and/or branching degree.

Branched IOS molecules are IOS molecules derived from internal olefin molecules which comprise one or more branches. Linear IOS molecules are IOS molecules derived from internal olefin molecules which are linear. An internal olefin may be a mixture of linear internal olefin molecules and branched internal olefin molecules. Analogously, an IOS may be a mixture of linear IOS molecules and branched IOS molecules. An internal olefin or IOS may be characterized by its carbon number and/or linearity.

An internal olefin or internal olefin sulfonate mixture may be characterized by its average carbon number. The average carbon number is determined by multiplying the number of carbon atoms of each molecule by the weight fraction of that molecule and then adding the products, resulting in a weight average carbon number. The average carbon number may be determined by gas chromatography (GC) analysis of the internal olefin.

Linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin.

Within the present specification, “branching index” (BI) refers to the average number of branches per molecule, which may be determined by dividing the total number of branches by the total number of molecules. The branching index may be determined by ¹H-NMR analysis.

When the branching index is determined by ¹H-NMR analysis, the total number of branches equals: [total number of branches on olefinic carbon atoms (olefinic branches)]+[total number of branches on aliphatic carbon atoms (aliphatic branches)]. The total number of aliphatic branches equals the number of methine groups, which latter groups are of formula R₃CH wherein R is an alkyl group. Further, the total number of olefinic branches equals: [number of trisubstituted double bonds]+[number of vinylidene double bonds]+2*[number of tetrasubstituted double bonds]. Formulas for the trisubstituted double bond, vinylidene double bond and tetrasubstituted double bond are shown below. In all of the below formulas, R is an alkyl group.

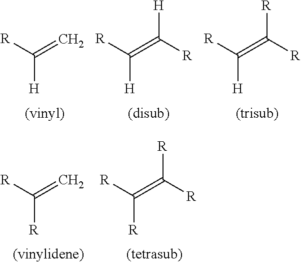

The average molecular weight is determined by multiplying the molecular weight of each surfactant molecule by the weight fraction of that molecule and then adding the products, resulting in a weight average molecular weight.

The foregoing passages regarding (average) carbon number, linearity, branching index and molecular weight apply analogously to the alkoxylated alcohol and/or alkoxylated alcohol derivative as further described below.

The hydrocarbon recovery composition comprises an internal olefin sulfonate (IOS) that is at least 40 wt. % linear, more preferably at least 50 wt. %, more preferably at least 60 wt. %, more preferably at least 70 wt. %, more preferably at least 80 wt. %, most preferably at least 90 wt. % linear. For example, 40 to 100 wt. %, more suitably 50 to 100 wt. %, more suitably 60 to 100 wt. %, more suitably 70 to 99 wt. %, most suitably 80 to 99 wt. % of the IOS may be linear. Branches in the IOS may include methyl, ethyl and/or higher molecular weight branches including propyl branches.

Preferably, the IOS is not substituted by groups other than sulfonate groups and optionally hydroxy groups. The IOS preferably has an average carbon number in the range of from 5 to 30, more preferably 10 to 30, more preferably 15 to 30, most preferably 17 to 28.

In one embodiment the IOS may be selected from the group consisting of C₁₋₁₈ IOS, C₁₉₋₂₃ IOS, C₂₀₋₂₄ IOS, C₂₄₋₂₈ IOS and mixtures thereof, wherein “IOS” stands for “internal olefin sulfonate”. Suitable internal olefin sulfonates include those from the ENORDET™ 0 series of surfactants commercially available from Shell Chemical.

“C₁₅₋₁₈ internal olefin sulfonate” (C₁₅₋₁₈ IOS) as used herein means a mixture of internal olefin sulfonate molecules wherein the mixture has an average carbon number of from 16 to 17 and at least 50% by weight, preferably at least 65% by weight, more preferably at least 75% by weight, most preferably at least 90% by weight, of the internal olefin sulfonate molecules in the mixture contain from 15 to 18 carbon atoms.

“C₁₉₋₂₃ internal olefin sulfonate” (C₁₉₋₂₃ IOS) as used herein means a mixture of internal olefin sulfonate molecules wherein the mixture has an average carbon number of from 21 to 23 and at least 50% by weight, preferably at least 60% by weight, of the internal olefin sulfonate molecules in the mixture contain from 19 to 23 carbon atoms.

“C₂₀₋₂₄ internal olefin sulfonate” (C₂₀₋₂₄ IOS) as used herein means a mixture of internal olefin sulfonate molecules wherein the mixture has an average carbon number of from 20 to 23 and at least 50% by weight, preferably at least 65% by weight, more preferably at least 75% by weight, most preferably at least 90% by weight, of the internal olefin sulfonate molecules in the mixture contain from 20 to 24 carbon atoms.

“C₂₄₋₂₈ internal olefin sulfonate” (C₂₄₋₂₈ IOS) as used herein means a mixture of internal olefin sulfonate molecules wherein the mixture has an average carbon number of from 24.5 to 27 and at least 40% by weight, preferably at least 45% by weight, of the internal olefin sulfonate molecules in the mixture contain from 24 to 28 carbon atoms.

Further, for the internal olefin sulfonates which are substituted by sulfonate groups, the cation may be any cation, such as an ammonium, alkali metal or alkaline earth metal cation, preferably an ammonium or alkali metal cation.

An IOS molecule is made from an internal olefin molecule whose double bond is located anywhere along the carbon chain except at a terminal carbon atom. Internal olefin molecules may be made by double bond isomerization of alpha olefin molecules whose double bond is located at a terminal position. Generally, such isomerization results in a mixture of internal olefin molecules whose double bonds are located at different internal positions. The distribution of the double bond positions is mostly thermodynamically determined. Further, that mixture may also comprise a minor amount of non-isomerized alpha olefins. Still further, because the starting alpha olefin may comprise a minor amount of paraffins (non-olefinic alkanes), the mixture resulting from alpha olefin isomeration may likewise comprise that minor amount of unreacted paraffins.

The amount of alpha olefins in the internal olefin may be up to 5%, for example 1 to 4 wt. % based on total composition. Further, the amount of paraffins in the internal olefin may be up to 2 wt. %, for example up to 1 wt. % based on total composition.

Suitable processes for making an internal olefin include those described in U.S. Pat. No. 5,510,306; U.S. Pat. No. 5,633,422; U.S. Pat. No. 5,648,584; U.S. Pat. No. 5,648,585; U.S. Pat. No. 5,849,960; and EP 0830315.

In the sulfonation step, the internal olefin is contacted with a sulfonating agent. The reaction of the sulfonating agent with an internal olefin leads to the formation of cyclic intermediates known as beta-sultones, which can undergo isomerization to unsaturated sulfonic acids and the more stable gamma- and delta-sultones.

In a next step, sulfonated internal olefin from the sulfonation step is contacted with a base containing solution. In this step, beta-sultones are converted into beta-hydroxyalkane sulfonates, whereas gamma- and delta-sultones are converted into gamma-hydroxyalkane sulfonates and delta-hydroxyalkane sulfonates, respectively. A portion of the hydroxyalkane sulfonates may be dehydrated into alkene sulfonates.

An IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Di-sulfonate molecules originate from a further sulfonation of for example an alkene sulfonic acid.

The IOS may comprise at least 30% hydroxyalkane sulfonate molecules, up to 70% alkene sulfonate molecules and up to 15% di-sulfonate molecules. Suitably, the IOS comprises from 40% to 95% hydroxyalkane sulfonate molecules, from 5% to 50% alkene sulfonate molecules and from 0% to 10% di-sulfonate molecules. Beneficially, the IOS comprises from 50% to 90% hydroxyalkane sulfonate molecules, from 10% to 40% alkene sulfonate molecules and from less than 1% to 5% di-sulfonate molecules. More beneficially, the IOS comprises from 70% to 90% hydroxyalkane sulfonate molecules, from 10% to 30% alkene sulfonate molecules and less than 1% di-sulfonate molecules. The composition of the IOS may be measured using a mass spectrometry technique.

U.S. Pat. No. 4,183,867; U.S. Pat. No. 4,248,793 and EP 0351928 disclose processes which can be used to make internal olefin sulfonates.

The hydrocarbon recovery composition additionally comprises an alkoxylated alcohol and/or alkoxylated alcohol derivative which is a compound of the formula (I)

R—O-[PO]ₓ[EO]_{y}-X Formula (I)

wherein R is a hydrocarbyl group, PO is a propylene oxide group, EO is an ethylene oxide group, x is the number of propylene oxide groups, y is the number of ethylene oxide groups; and X is selected from the group consisting of: (i) a hydrogen atom; (ii) a group comprising a carboxylate moiety; (iii) a group comprising a sulfate moiety; and (iv) a group comprising a sulfonate moiety.

The hydrocarbyl group R in formula (I) is preferably aliphatic. When the hydrocarbyl group R is aliphatic, it may be an alkyl group, cycloalkyl group or alkenyl group, suitably an alkyl group. The hydrocarbyl group is preferably an alkyl group. The hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. The hydrocarbyl group R in the above formula (I) preferably originates from a non-alkoxylated alcohol R—OH which only contains 1 hydroxyl group (mono-alcohol). Further, the alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, the number of branches for the aliphatic group R, and the molecular weight. Generally, the hydrocarbyl group R may be a branched hydrocarbyl group or an unbranched (linear) hydrocarbyl group. Further, the hydrocarbyl group R is preferably a branched hydrocarbyl group which has a branching index equal to or greater than 0.3.

The hydrocarbyl group R in the above formula (I) is preferably an alkyl group. The alkyl group has a weight average carbon number within a wide range, namely 5 to 32, more suitably 6 to 25, more suitably 7 to 22, more suitably 8 to 20, most suitably 9 to 17. In a case where the alkyl group contains 3 or more carbon atoms, the alkyl group is attached either via its terminal carbon atom or an internal carbon atom to the oxygen atom, preferably via its terminal carbon atom. Further, the weight average carbon number of the alkyl group is at least 5, preferably at least 6, more preferably at least 7, more preferably at least 8, more preferably at least 9, more preferably at least 10, more preferably at least 11, most preferably at least 12. Still further, the weight average carbon number of the alkyl group is at most 32, preferably at most 25, more preferably at most 20, more preferably at most 17, more preferably at most 16, more preferably at most 15, more preferably at most 14, most preferably at most 13.

Further, the alkyl group R in the above formula (I) is preferably a branched alkyl group which has a branching index equal to or greater than 0.3. The branching index of the alkyl group R in the above formula (I) is preferably of from 0.3 to 3.0, most preferably 1.2 to 1.4. Further, the branching index is at least 0.3, preferably at least 0.5, more preferably at least 0.7, more preferably at least 0.9, more preferably at least 1.0, more preferably at least 1.1, most preferably at least 1.2. Still further, the branching index is preferably at most 3.0, more preferably at most 2.5, more preferably at most 2.2, more preferably at most 2.0, more preferably at most 1.8, more preferably at most 1.6, most preferably at most 1.4.

The alkylene oxide groups in the above formula (I) comprise ethylene oxide (EO) groups or propylene oxide (PO) groups or a mixture of ethylene oxide and propylene oxide groups. In addition, other alkylene oxide groups may be present, such as butylene oxide groups. Preferably, the alkylene oxide groups consist of ethylene oxide groups or propylene oxide groups or a mixture of ethylene oxide and propylene oxide groups. In case of a mixture of different alkylene oxide groups, the mixture may be random or blockwise, preferably blockwise. In the case of a blockwise mixture of ethylene oxide and propylene oxide groups, the mixture preferably contains one EO block and one PO block, wherein the PO block is attached via an oxygen atom to the hydrocarbyl group R.

In the above formula (I), x is the number of propylene oxide groups and is of from 0 to 80. The average value for x is of from 1 to 80, preferably of from 20 to 50, and more preferably from 35 to 50. The average number of propylene oxide groups is referred to as the average PO number.

Further, in the above formula (I), y is the number of ethylene oxide groups and is of from 0 to 60. The average value for y is of from 1 to 80, preferably of from 20 to 50, and more preferably from 35 to 50. The average number of ethylene oxide groups is referred to as the average EO number

In the above formula (I), the sum of x and y is the number of propylene oxide and ethylene oxide groups and is of from 5 to 150. The average value for the sum of x and y is of from 5 to 90, and may be of from 20 to 60, or of from 30 to 55.

In the above formula (I), y may be 0, in which case the alkylene oxide groups in the above formula (I) comprise PO groups but no EO groups. In the latter case, the average value for the sum of x and y equals the above-described average value for x.

In the above formula (I), x may be 0, in which case the alkylene oxide groups in the above formula (I) comprise EO groups but no PO groups. In the latter case, the average value for the sum of x and y equals the above-described average value for y.

Further, in the above formula (I), each of x and y may be at least 1, in which case the alkylene oxide groups in the above formula (I) comprise PO and EO groups. In the latter case, the average value for the sum of x and y may be of from 1 to 80, suitably of from 20 to 60, and more suitably of from 35 to 50.

Where X in the above formula (I) is a hydrogen atom, each of x and y is preferably at least 1, in which case the alkylene oxide groups in the above formula (I) comprise PO and EO groups.

The alkoxylated alcohol and/or alkoxylated alcohol derivative of the above formula (I) may be a liquid, a waxy liquid or a solid at 20° C. In particular, it is preferred that at least 50 wt. %, suitably at least 60 wt. %, more suitably at least 70 wt. % of the alkoxylated alcohol and/or alkoxylated alcohol derivative is liquid at 20° C. Further, in particular, it is preferred that of from 50 to 100 wt. %, suitably of from 60 to 100 wt. %, more suitably of from 70 to 100 wt. % of the alkoxylated alcohol and/or alkoxylated alcohol derivative is liquid at 20° C.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306; U.S. Pat. No. 5,648,584 and U.S. Pat. No. 5,648,585. Preparations of branched long chain aliphatic alcohols are described in U.S. Pat. No. 5,849,960; U.S. Pat. No. 6,150,222; U.S. Pat. No. 6,222,077.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which are commonly used commercially. Alternatively, a double metal cyanide catalyst may be used, as described in U.S. Pat. No. 6,977,236. Still further, a lanthanum-based or a rare-earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, which catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with 7 moles of alkylene oxide per mole of primary alcohol results in the alkoxylation of each alcohol molecule with an average of 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Non-alkoxylated alcohols R—OH, from which the hydrocarbyl group R in the above formula (I) for the alkoxylated alcohol and/or alkoxylated alcohol derivative originates, wherein R is a branched alkyl group which has a branching index equal to or greater than 0.3 and which has a weight average carbon number of from 5 to 32, are commercially available. A suitable example of a commercially available alcohol mixture is NEODOL™ 67, which includes a mixture of C₁₆ and C₁₇ alcohols of the formula R—OH, wherein R is a branched alkyl group having a branching index of about 1.3, sold by Shell Chemical LP. NEODOL™ as used throughout this text is a trademark. Shell Chemical LP also manufactures a C₁₂/C₁₃ analogue alcohol of NEODOL™ 67, which includes a mixture of C₁₂ and C₁₃ alcohols of the formula R—OH, wherein R is a branched alkyl group having a branching index of about 1.3, and which is used to manufacture alcohol alkoxylate sulfate (AAS) products branded and sold as ENORDET™ enhanced oil recovery surfactants. Another suitable example is EXXAL™ 13 tridecylalcohol (TDA), sold by ExxonMobil, which is of the formula R—OH wherein R is a branched alkyl group having a branching index of about 2.9 and having a carbon number distribution wherein 30 wt. % is C₁₂, 65 wt. % is C₁₃ and 5 wt. % is C₁₄. Yet another suitable example is MARLIPAL® tridecylalcohol (TDA), sold by Sasol, which product is of the formula R—OH wherein R is a branched alkyl group having a branching index of about 2.2 and having 13 carbon atoms.

Further, in the above formula (I) for the alkoxylated alcohol and/or alkoxylated alcohol derivative, X may be a group comprising a carboxylate, sulfate or sulfonate moiety, which are anionic moieties.

In the above-mentioned embodiments of the invention, wherein the alkoxylated alcohol derivative is of the above formula (I) and X in the above formula (I) is a group comprising an anionic moiety, the cation may be any cation, such as an ammonium, protonated amine, alkali metal or alkaline earth metal cation, preferably an ammonium, protonated amine or alkali metal cation, most preferably an ammonium or protonated amine cation. Examples of suitable protonated amines are protonated methylamine, protonated ethanolamine and protonated diethanolamine. Surfactants of the formula (I) wherein X is a group comprising an anionic moiety may be prepared from the above-described alkoxylated alcohols of the formula R—O-[PO]ₓ[EO]_{y}-H, as is further described hereinbelow.

In a case where X in the above formula (I) is a group comprising a carboxylate moiety, the alkoxylated alcohol derivative is of the formula (II)

R—O-[PO]ₓ[EO]_{y}-L-C(═O)O⁻ Formula (II)

wherein R, PO, EO, x and y have the above-described meanings and L is an alkyl group, suitably a C₁-C₄ alkyl group, which may be unsubstituted or substituted, and wherein the —C(═O)O⁻ moiety is the carboxylate moiety.

The alkoxylated alcohol R—O-[PO]ₓ[EO]_{y}-H may be carboxylated by any known method. It may be reacted, preferably after deprotonation with a base, with a halogenated carboxylic acid, for example chloroacetic acid, or a halogenated carboxylate, for example sodium chloroacetate. Alternatively, the alcoholic end group may be oxidized to yield a carboxylic acid, in which case the number x (number of alkylene oxide groups) is reduced by 1. Any carboxylic acid product may then be neutralized with an alkali metal base to form a carboxylate surfactant.

In a specific example, an alcohol is reacted with potassium t-butoxide and initially heated at 60° C. under reduced pressure for 10 hours. After allowing it to cool, sodium chloroacetate is added to the mixture. The reaction temperature is increased to 90° C. under reduced pressure and heating at the temperature would take place for 20-21 hours. It is cooled to room temperature and water and hydrochloric acid are added. This is heated at 90° C. for 2 hours. The organic layer is extracted by adding ethyl acetate and washing it with water.

In a case where X in the above formula (I) is a group comprising a sulfate moiety, the surfactant is of the formula (III)

R—O-[PO]ₓ[EO]_{y}-SO₃⁻ Formula (III)

wherein R, PO, EO, x and y have the above-described meanings, and wherein the —O—SO₃⁻ moiety is the sulfate moiety.

The alcohol R—O-[PO]ₓ[EO]_{y}-H may be sulfated by any known method, for example by contacting the alcohol with a sulfating agent including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature of at most 80° C. The sulfation may be carried out at temperature as low as −20° C. For example, the sulfation may be carried out at a temperature from 20 to 70° C., preferably from 20 to 60° C., and more preferably from 20 to 50° C.

The alcohol may be reacted with a gas mixture which in addition to at least one inert gas contains from 1 to 8 vol. %, relative to the gas mixture, of gaseous sulfur trioxide, preferably from 1.5 to 5 vol. %. Although other inert gases are also suitable, air or nitrogen are preferred.

The reaction of the alcohol with the sulfur trioxide containing inert gas may be carried out in falling film reactors. Such reactors utilize a liquid film trickling in a thin layer on a cooled wall which is brought into contact with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from 0 to 65° C. and a pressure in the range from 100 to 200 kPa.

In a case where X in the above formula (I) is a group comprising a sulfonate moiety, the alkoxylated alcohol derivative is of the formula (IV)

R—O-[PO]ₓ[EO]_{y}-L-S(═O)₂O Formula (IV)

wherein R, PO, EO, x and y have the above-described meanings and L is an alkyl group, suitably a C₁-C₄ alkyl group, which may be unsubstituted or substituted, and wherein the —S(═O)₂O⁻ moiety is the sulfonate moiety.

The alkoxylated alcohol R—O-[PO]ₓ[EO]_{y}-H may be sulfonated by any known method. It may be reacted, preferably after deprotonation with a base, with a halogenated sulfonic acid, for example chloroethyl sulfonic acid, or a halogenated sulfonate, for example sodium chloroethyl sulfonate. Any resulting sulfonic acid product may then be neutralized with an alkali metal base to form a sulfonate surfactant.

Particularly suitable sulfonate surfactants are glycerol sulfonates. Glycerol sulfonates may be prepared by reacting the alkoxylated alcohol R—O-[PO]ₓ[EO]_{y}-H with epichlorohydrin, preferably in the presence of a catalyst such as tin tetrachloride, for example at from 110 to 120° C. and for from 3 to 5 hours at a pressure of 14.7 to 15.7 psia (100 to 110 kPa) in toluene. Next, the reaction product is reacted with a base such as sodium hydroxide or potassium hydroxide, for example at from 85 to 95° C. for from 2 to 4 hours at a pressure of 14.7 to 15.7 psia (100 to 110 kPa). The reaction mixture is cooled and separated in two layers. The organic layer is separated and the product isolated. It may then be reacted with sodium bisulfite and sodium sulfite, for example at from 140 to 160° C. for from 3 to 5 hours at a pressure of 60 to 80 psia (400 to 550 kPa). The reaction is cooled and the product glycerol sulfonate is recovered. Such glycerol sulfonate has the formula R—O-[PO]ₓ[EO]_{y}-CH₂—CH(OH)—CH₂—S(═O)₂O⁻.

In addition to or instead of the above-described alkoxylated alcohol and/or alkoxylated alcohol derivative of formula (I), wherein the hydrocarbyl group is a branched hydrocarbyl group which has a branching index equal to or greater than 0.3, the hydrocarbon recovery composition may also comprise one or more non-ionic surfactants of the formula (V)

R—O-[EO]_{y}-H Formula (V)

wherein R is a hydrocarbyl group which has a branching index of from 0 to lower than 0.3 and which has a weight average carbon number of from 4 to 25, EO is an ethylene oxide group, y is the number of ethylene oxide groups and is at least 0.5.

The alcohol R—OH used to make the non-ionic surfactant of the formula (V) may be primary or secondary, preferably primary. The hydrocarbyl group R in the formula (V) is preferably aliphatic. When the hydrocarbyl group R is aliphatic, it may be an alkyl group, cycloalkyl group or alkenyl group, suitably an alkyl group. The hydrocarbyl group is preferably an alkyl group.

The weight average carbon number for the hydrocarbyl group R in the formula (V) is not essential and may vary within wide ranges, such as from 4 to 25, suitably 6 to 20, more suitably 8 to 15. Further, the hydrocarbyl group R in the formula (V) may be linear or branched and has a branching index of from 0 to lower than 0.3, suitably of from 0.1 to lower than 0.3.

In the formula (V), y is the number of ethylene oxide groups. The non-ionic surfactant of the formula (V), preferably has an average value for y that is at least 0.5. The average value for y may be of from 1 to 20, more suitably 4 to 16, most suitably 7 to 13.

The weight ratio of (1) the internal olefin sulfonate (IOS) to (2) the above-mentioned non-ionic surfactant of the formula (V) may vary within wide ranges and may be of from 1:100 to 20:100, suitably of from 2:100 to 15:100. Further, the weight ratio of (1) the above-described alkoxylated alcohol and/or alkoxylated alcohol derivative of formula (I) wherein the hydrocarbyl group is a branched hydrocarbyl group which has a branching index equal to or greater than 0.3 to (2) the above-mentioned non-ionic surfactant of the formula (V) may also vary within wide ranges and may be of from 1:0.1 to 1:10, suitably of from 1:0.2 to 1:5, more suitably of from 1:0.3 to 1:2.

The above-mentioned, optional non-ionic surfactant of the formula (V) and/or the alkoxylated alcohol and/or alkoxylated alcohol derivative of the formula (I) as contained in the hydrocarbon recovery composition may be added during or after preparation of the internal olefin sulfonate. For example, they may be added as a process aid prior to or during either the neutralisation or hydrolysis stages of IOS manufacture, or they may be added after the hydrolysis stage.

Suitable examples of commercially available ethoxylated alcohol mixtures, which can be used as the above-mentioned non-ionic surfactants of the formula (V), include the NEODOL™ (NEODOL™, as used throughout this text, is a trademark) alkoxylated alcohols, sold by Shell Chemical Company, including mixtures of ethoxylates of C₉, C₁₀ and C₁₁ alcohols wherein the average value for the number of the ethylene oxide groups is 8 (NEODOL™ 91-8 alcohol ethoxylate); mixtures of ethoxylates of C₁₄ and C₁₅ alcohols wherein the average value for the number of the ethylene oxide groups is 7 (NEODOL™ 45-7 alcohol ethoxylate); and mixtures of ethoxylates of C₁₂, C₁₃, C₁₄ and C₁₅ alcohols wherein the average value for the number of the ethylene oxide groups is 12 (NEODOL™ 25-12 alcohol ethoxylate).

A cosolvent (or solubilizer) may be added to increase the solubility of the surfactants in the hydrocarbon recovery composition and/or in the below-mentioned injectable fluid comprising the composition. Suitable examples of cosolvents are polar cosolvents, including lower alcohols (for example sec-butanol and isopropyl alcohol) and polyethylene glycol. Any amount of cosolvent needed to dissolve the surfactant at a certain salt concentration (salinity) may be easily determined by a skilled person through routine tests.

A hydrotrope may be added to increase the solubility of the surfactants in the hydrocarbon recovery composition and/or in the below-mentioned injectable fluid comprising the composition. Suitable examples of hydrotropes include both aryl and non-aryl compounds. The aryl compounds are generally aryl sulfonates or short-chain alkyl-aryl sulfonates in the form of their alkali metal salts (for example sodium toluene sulfonate, potassium toluene sulfonate, sodium xylene sulfonate, ammonium xylene sulfonate, potassium xylene sulfonate, calcium xylene sulfonate, sodium cumene sulfonate, and ammonium cumene sulfonate). Suitable examples of non-aryl hydrotropes are sulfonates whose alkyl moiety contains from 1 to 8 carbon atoms (for example butane sulfonate and hexane sulfonate).

Viscosity modifiers other than the above-described alkoxylated alcohol and/or alkoxylated alcohol derivative of formula (I) may be used in addition to the alkoxylated alcohol and/or alkoxylated alcohol derivative and be included in the hydrocarbon recovery composition. An embodiment of a viscosity modifier is a linear or branched C₁ to C₆ monoalkylether of mono- or di-ethylene glycol. Suitable examples are diethylene glycol monobutyl ether (DGBE), ethylene glycol monobutyl ether (EGBE) and triethylene glycol monobutyl ether (TGBE). Further, a linear or branched C₁ to C₆ dialkylether of mono-, di- or triethylene glycol, such as ethylene glycol dibutyl ether (EGDE), may be used as a further viscosity modifier.

The hydrocarbon recovery composition may comprise a base (herein also referred to as “alkali”), preferably an aqueous soluble base, including alkali metal containing bases such as for example sodium carbonate and sodium hydroxide.

The hydrocarbon recovery composition may additionally comprise an acid which has a pKₐ between 6 and 12 and the conjugate base of such acid. The acid/conjugate base mixture may function as a stabilizing buffer. An aqueous hydrocarbon recovery composition comprising such acid and conjugate base may be combined with a hydrocarbon removal fluid to produce an injectable fluid, wherein the hydrocarbon removal fluid 1) comprises water (e.g. a brine) and 2) may comprise divalent cations in any concentration, suitably in a concentration of 100 or more parts per million by weight (ppmw), after which the injectable fluid may be injected into the hydrocarbon containing formation. The acid which has a pKₐ between 6 and 12 and the conjugate base of such acid, and amounts and concentrations of these, may be any one of those as disclosed in US 2016/0177173.

The hydrocarbon recovery composition may be combined with a fracturing fluid and injected into the hydrocarbon formation in conjunction with a fracturing step. For example, when it is desirable to subject a formation to hydraulic fracturing, the fracturing fluid may be mixed with the hydrocarbon recovery composition before it is injected into the formation.

The hydrocarbon recovery composition may be combined with one or more additional components selected from: guar gum, HPAM polymer, clay stabilizers, oxygen scavengers, corrosion inhibitors, biocides, scale inhibitors, pH buffers, crosslinkers, breakers or additional surfactants.

In another embodiment, the hydrocarbon recovery composition may be injected into the formation in the absence of polymer. This embodiment is typically used when the hydrocarbon recovery composition is injected to stimulate a formation that has already had a significant amount of hydrocarbon produced therefrom.

The present invention further relates to a method of treating a hydrocarbon containing formation, comprising the following steps:

a) feeding a hydrocarbon recovery composition into the formation;

b) allowing the hydrocarbon recovery composition to contact the formation for a period of time, and;

c) withdrawing a mixture of the hydrocarbon recovery composition and hydrocarbons from the formation.

A “hydrocarbon containing formation” is defined as a sub-surface hydrocarbon containing formation.

In the method of treating a hydrocarbon containing formation, the surfactants (an internal olefin sulfonate (IOS) and/or an alkoxylated alcohol and/or alkoxylated alcohol derivative) may be used to stimulate a hydrocarbon containing formation that has already had a significant amount of hydrocarbon produced therefrom. Such a formation may have been dormant for some time as the primary recovery of hydrocarbon was already completed. This stimulation may occur by providing the hydrocarbon recovery composition to at least a portion of the hydrocarbon containing formation and then allowing the surfactants from the composition to interact with the hydrocarbon containing formation. After this time, additional hydrocarbon may be produced from the hydrocarbon containing formation.

The hydrocarbon containing formation may be a crude oil-bearing formation. Different crude oil-bearing formations or reservoirs differ from each other in terms of crude oil type. First, the API may differ among different crude oils. Further, different crude oils comprise varying amounts of saturates, aromatics, resins and asphaltenes. The 4 components are commonly abbreviated as “SARA”. Further, crude oils comprise varying amounts of acidic and basic components, including naphthenic acids and basic nitrogen compounds. Still further, crude oils comprise varying amounts of paraffin wax. These components are present in heavy (low API) crude oils and light (high API) crude oils. The overall distribution of such components in a crude oil is a direct result of geochemical processes. The properties of the crude oil in the crude oil-bearing formation may differ widely. For example, in respect of the API and the amounts of the above-mentioned crude oil components comprising saturates, aromatics, resins, asphaltenes, acidic and basic components (including naphthenic acids and basic nitrogen compounds) and paraffin wax, the crude oil may be of one of the types as disclosed in WO 2013030140 and US 2016/0177172.

Normally, surfactants for enhanced hydrocarbon recovery are transported to a hydrocarbon recovery location and stored at that location in the form of an aqueous composition containing for example 15 to 35 wt. % surfactant. At the hydrocarbon recovery location, the surfactant concentration of such composition would then be further reduced to 0.05-2 wt. %, by diluting the composition with water or brine, before it is injected into a hydrocarbon containing formation. By such dilution with water or brine, an aqueous fluid is formed which fluid can be injected into the hydrocarbon containing formation. Advantageously, a more concentrated aqueous composition having an active matter content of for example 40 wt. %, as described above, may be transported to the location and stored there, provided the alkoxylated alcohol and/or alkoxylated alcohol derivative is added to such more concentrated aqueous composition, such that the weight ratio of the alkoxylated alcohol and/or alkoxylated alcohol derivative to the internal olefin sulfonate is below 1:1. A further advantage is that the water or brine used in such further dilution, which water or brine may originate from the hydrocarbon containing formation (from which hydrocarbons are to be recovered) or from any other source, may have a relatively high concentration of divalent cations, suitably in the above-described ranges. One of the advantages of that is that such water or brine no longer has to be pre-treated (softened) such as to remove the divalent cations, thereby resulting in significant savings in time and costs.

The total amount of the surfactants in the injectable fluid may be of from 0.05 to 2 wt. %, preferably 0.1 to 1.5 wt. %, more preferably 0.1 to 1.2 wt. %, most preferably 0.2 to 1.0 wt. %.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur.

Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilization of hydrocarbons through the hydrocarbon containing formation.

The hydrocarbon containing formation may have a low permeability, for example, of less than 100 millidarcy (mD). Such a formation may be called a “tight” formation, and it is difficult to use standard methods to produce hydrocarbon from such a formation. The permeability is measured in the matrix of the hydrocarbon containing formation. In another embodiment, the permeability of the formation is in a range of from 300 nanodarcy (nD) to 100 mD. In one embodiment, the permeability may be in the range of from 300 nD to 50,000 nD. In another embodiment, the permeability may be in the range of from 0.001 mD to 0.01 mD. In still another embodiment, the permeability may be in the range of from 0.01 mD to 100 mD.

In one embodiment, the hydrocarbon containing formation comprises shale. In another embodiment, the hydrocarbon containing formation is a carbonate formation. In another embodiment, the hydrocarbon containing formation may comprise tight sandstone. The hydrocarbon containing formation may be fractured either naturally or purposefully, e.g., hydraulically fractured.

The temperature of the hydrocarbon containing formation may be in a range of from 20 to 150° C. In one embodiment, the temperature of the hydrocarbon containing formation is in the range of from 20 to 50° C. In another embodiment, the temperature of the hydrocarbon containing formation is in the range of from 80 to 120° C.

The hydrocarbon containing formation typically comprises an aqueous fluid referred to as brine. The brine in the hydrocarbon containing formation may have a total dissolved solids (TDS) of from 1 to 35 wt %. In one embodiment, the total dissolved solids in the brine in the formation is from 1 to 5 wt %. In another embodiment, the total dissolved solids in the brine in the formation is from 15 to 32 wt %.

The aforementioned method for recovering hydrocarbons from the hydrocarbon containing formation may be a huff and puff method where the hydrocarbon recovery composition is injected into the formation and allowed to interact with the formation for a certain period of time. After that period of time, a mixture of the hydrocarbon recovery composition and the hydrocarbon is produced from the formation.

In one embodiment the period of time may be at least 6 hours. Under certain conditions, this period of time could be even less than 6 hours, but this could have practical limitations depending on the size of the formation and the required volume of hydrocarbon recovery composition to be injected.

In another embodiment, the period of time is from 6 hours to 3 months. It is possible that the period of time could be even longer than 3 months, but additional time beyond 3 months may not produce sufficiently improved results to justify the extended time period. In another embodiment, the period of time may be from 12 hours to 2 months.

In one embodiment of this method, the hydrocarbon recovery composition may be injected into one or more wells and after the period of time, the mixture of the hydrocarbon recovery composition and the hydrocarbon would be produced through those same one or more wells. This is different from a typical chemical enhanced oil recovery flood where the surfactants are injected into one or more wells to “push” the hydrocarbon to another one or more production wells.

While not wishing to be bound to a specific theory, it is believed that this method uses the physical chemistry of surfactant adsorption to alter the rock wettability of the formation to more water wet while simultaneously lowering the oil water interfacial tension. This drives water imbibition into the rock matrix of the hydrocarbon containing formation, and by mass balance, hydrocarbon is pushed out of the rock matrix and produced from the formation.

1. A hydrocarbon recovery composition comprising one or more internal olefin sulfonates and/or one or more alkoxylated alcohols and/or alkoxylated alcohol derivatives.

2. The composition of claim 1 wherein the alkoxylated alcohols or alkoxylated alcohol derivatives have an average EO number of from 1 to 80.

3. The composition of claim 1 wherein the alkoxylated alcohols or alkoxylated alcohol derivatives have an average EO number of from 20 to 60.

4. The composition of claim 1 wherein the alkoxylated alcohols or alkoxylated alcohol derivatives have an average EO number of from 35 to 50.

5. The composition of claim 1 wherein the alkoxylated alcohol derivatives are alcohol ethoxy sulfates.

6. The composition of claim 1 wherein at least 50 wt % of the internal olefin sulfonates have from 14 to 19 carbon atoms per molecule.

7. A method of recovering hydrocarbons from a hydrocarbon formation comprising feeding a hydrocarbon recovery composition into the formation, allowing the hydrocarbon recovery composition to contact the formation for a period of time, and withdrawing a mixture of the hydrocarbon recovery composition and hydrocarbons from the formation.

8. The method of claim 7 wherein the hydrocarbon recovery composition is fed into the formation through one or more wells and the mixture of the hydrocarbon recovery composition and the hydrocarbons is withdrawn through the same one or more wells.

9. The method of claim 7 wherein the hydrocarbon recovery composition is fed into the formation at the same time as a fracturing fluid.

10. The method of claim 7 wherein the period of time is from 6 hours to 3 months.

11. The method of claim 7 wherein period of time is from 12 hours to 2 months.

12. The method of claim 7 wherein the hydrocarbon recovery composition comprises one or more internal olefin sulfonates and/or one or more alkoxylated alcohols and/or alkoxylated alcohol derivatives.

13. The method of claim 7 wherein the hydrocarbon recovery composition further comprises one or more additional components selected from: guar gum, HPAM polymer, clay stabilizers, oxygen scavengers, corrosion inhibitors, biocides, scale inhibitors, pH buffers, crosslinkers, breakers or additional surfactants.

14. The method of claim 7 wherein at least a portion of the hydrocarbon formation matrix has a permeability of from 300 nD to 100 mD.

15. The method of claim 7 wherein at least a portion of the hydrocarbon formation matrix has a permeability of from 300 nD to 50,000 nD.

16. The method of claim 7 wherein at least a portion of the hydrocarbon formation matrix has a permeability of from 0.001 mD to 0.01 mD.

17. The method of claim 7 wherein at least a portion of the hydrocarbon formation matrix has a permeability of from 0.01 mD to 100 mD.

18. The method of claim 7 wherein the temperature of the hydrocarbon formation is in the range of from 20 to 150° C.

19. The method of claim 7 wherein the hydrocarbon formation comprises brine having a total dissolved solids (TDS) of from 1 to 35 wt %.
